(19) United States
(12) Patent Application Publication
(10) Pub. No.: US 2023/0096031 A1
(43) Pub. Date: Mar. 30, 2023

(54) NC PROGRAM CONVERSION PROCESSING METHOD, CONVERSION COMPUTER, AND CONVERSION PROGRAM

(71) Applicant: HITACHI, LTD., Tokyo (JP)

(72) Inventors: Yasutaka KEDO, Tokyo (JP); Ippei KONO, Tokyo (JP); Akihiro YOSHIDA, Tokyo (JP); Koji UTSUMI, Tokyo (JP)

(21) Appl. No.: 17/795,614

(22) PCT Filed: Sep. 8, 2020
(86) PCT No.: PCT/JP2020/033859

§ 371 Date: Jul. 27, 2022

(30) Foreign Application Priority Data
Mar. 27, 2020 (JP) 2020-057557

(51) Int. Cl. G05B 19/4093; G05B 19/18

(52) U.S. Cl. CPC G05B 19/40937; G05B 19/182; G05B 2219/35534; G05B 2219/37355

(57) ABSTRACT

A numerical control (NC) program is converted regardless of a machining form of a workpiece. An NC program conversion processing method is an NC program conversion processing method for converting a conversion source NC program that controls a first machining center into a conversion destination NC program that controls a second machining center, which includes: a determination step of determining a machining form of a workpiece by the conversion source NC program; a decision step of deciding a correction method to be one-direction correction or two-direction correction according to the determined machining form of the workpiece; and a conversion step of converting the conversion source NC program into the conversion destination NC program using the decided correction method.

### TECHNICAL FIELD

The present invention relates to an NC program conversion processing method, a conversion computer, and a conversion program. The invention claims priority of Japanese Patent Application number 2020-057557, filed on Mar. 27, 2020, and regarding the designated countries that are permitted to be incorporated by reference in the literature, the content of that application will be incorporated into the present application by reference.

### BACKGROUND ART

In recent years, an NC cutting machine such as a machining center that machines an object to be machined (hereinafter, referred to as a workpiece) into a predetermined shape based on a program for numerical control (NC) (hereinafter, referred to as an NC program) has become widespread.

With respect to an NC program, for example, PTL 1 discloses an NC program conversion processing method including: specifying, based on a plurality of blocks in a conversion source NC program 146, a non-contact portion tool path which is a path in which a tool of a machine executing the conversion source NC program does not come into contact with a workpiece during processing corresponding to a block; specifying a non-contact block which is a block having only the non-contact portion tool path as a path; deciding a tool route correction amount in a tool diameter direction in a machining processing of a workpiece according to following blocks which are one or more of blocks following the non-contact block; and creating a block including a description for correcting a tool route by the tool route correction amount before a following block.

### CITATION LIST

### Patent Literature

PTL 1: Japanese Patent No. 6629410

### SUMMARY OF INVENTION

### Technical Problem

According to the NC program conversion processing method disclosed in PTL 1, an NC program that controls side surface machining of a workpiece and is tuned to be suitable for a first NC cutting machine can be converted into an NC program suitable for a second NC cutting machine by using one-direction correction such as tool route correction.

However, depending on a machining form of the workpiece, two-direction correction is required when the NC program is converted. Therefore, in the NC program conversion processing method disclosed in PTL 1, the NC program cannot be appropriately converted.

The invention has been made in view of the above points, and an object of the invention is to make it possible to convert an NC program regardless of a machining form of a workpiece.

### Solution to Problem

The present application includes a plurality of portions for solving at least a part of the above problem, and examples thereof are as follows.

In order to solve the above problem, an NC program conversion processing method according to an aspect of the invention is an NC program conversion processing method for converting a conversion source NC program that controls a first machining center into a conversion destination NC program that controls a second machining center, which includes: a determination step of determining a machining form of a workpiece by the conversion source NC program; a decision step of deciding a correction method to be one-direction correction or two-direction correction according to the determined machining form of the workpiece; and a conversion step of converting the conversion source NC program into the conversion destination NC program using the decided correction method.

### Advantageous Effects of Invention

According to the invention, an NC program can be converted regardless of a machining form of a workpiece.

Problems, configurations, and effects other than those described above will become apparent based on the following description of an embodiment.

### BRIEF DESCRIPTION OF DRAWINGS

FIG. 1 is a diagram showing a configuration example of a machining system according to an embodiment of the invention.

FIG. 2 is a diagram showing a configuration example of a conversion computer.

FIG. 3 is a flowchart showing an example of a conversion processing.

[FIG. 4] (A) and (B) of FIG. 4 are examples of NC programs that control curved surface machining, in which (A) of FIG. 4 is a diagram showing a conversion source NC program and (B) of FIG. 4 is a diagram showing a conversion destination NC program.

[FIG. 5] (A) and (B) of FIG. 5 are examples of NC programs that control side surface machining, in which (A) of FIG. 5 is a diagram showing a conversion source NC program and (B) of FIG. 5 is a diagram showing a conversion destination NC program.

FIG. 6 is a diagram showing a method of providing interpolation points in two-direction correction.

### DESCRIPTION OF EMBODIMENTS

Hereinafter, an embodiment of the invention will be described with reference to the drawings. The same components are denoted by the same reference signs in principle throughout all the drawings for showing the embodiment, and the repetitive description thereof is omitted. In the following embodiment, it is needless to say that constituent elements (including element steps and the like) are not necessarily essential unless otherwise particularly specified or clearly considered as essential in principle. It is needless to say that expressions “formed of A”, “made of A”, “having A”, and “including A” do not exclude elements other than A unless otherwise stated that A is the only element thereof. Similarly, in the following embodiment, shapes, positional relationship, or the like of the constituent elements or the like include those substantially approximate or similar to the shapes or the like unless otherwise particularly specified or when it is clearly considered that this is not the case in principle.

### Configuration Example of Machining System According to Embodiment of Invention

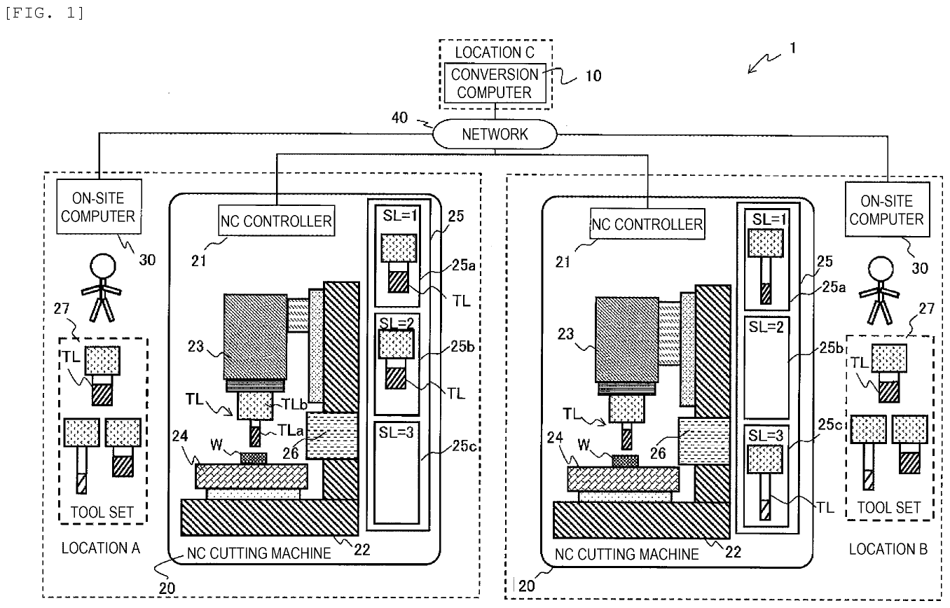

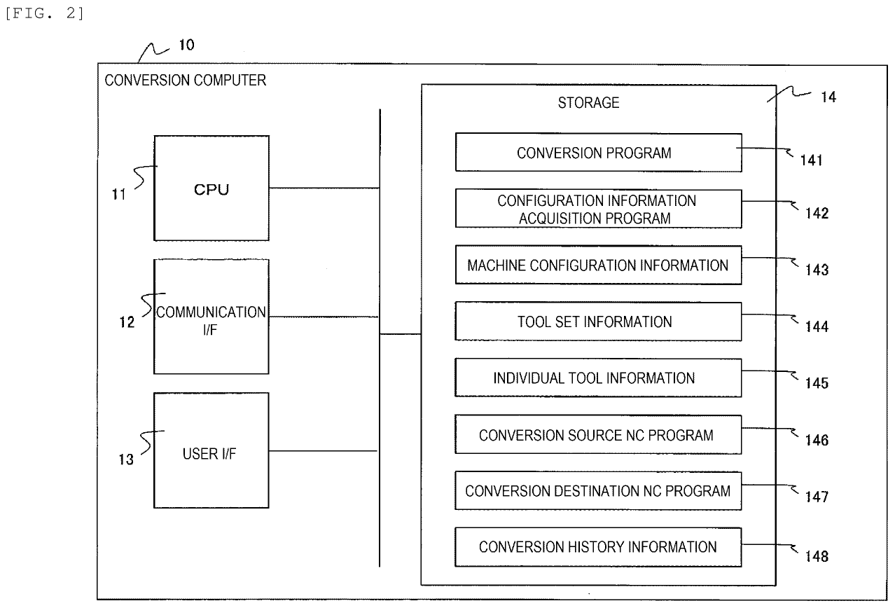

FIG. 1 shows a configuration example of a machining system 1 according to an embodiment of the invention.

The machining system 1 includes a conversion computer 10, a plurality of NC cutting machines 20, and a plurality of on-site computers 30.

The conversion computer 10 is disposed at a location C. The NC cutting machine 20 is installed at each of locations A and B. The on-site computer 30 is disposed on a machine side of the NC cutting machine 20, that is, at each of the locations A and B.

The conversion computer 10 may be disposed at the location A or the location B. A plurality of combinations of the NC cutting machine 20 and the on-site computer 30 may be disposed at the same location; for example, two sets of the NC cutting machine 20 and the on-site computer 30 may be disposed at the location A. Hereinafter, when it is necessary to distinguish between the NC cutting machines 20 disposed at the locations A and B, the NC cutting machine 20 disposed at the location A is referred to as an NC cutting machine 20A, and the NC cutting machine 20 disposed at the location B is referred to as an NC cutting machine 20B. The similar applies to the on-site computer 30.

The conversion computer 10, the NC cutting machine 20, and the on-site computer 30 are connected to each other via a network 40. The network 40 is a bidirectional communication network such as the Internet or a mobile phone communication network.

The conversion computer 10 includes a general computer such as a personal computer including a processor such as a central processing unit (CPU), a storage, a communication interface, an input device, and a display device. The conversion computer 10 executes a conversion processing for converting an NC program (conversion source NC program) tuned to be suitable for one NC cutting machine 20 into an NC program (conversion destination NC program) suitable for another NC cutting machine 20.

In the following, a case in which a conversion source NC program tuned to be suitable for the NC cutting machine 20A is converted into a conversion destination NC program suitable for the NC cutting machine 20B will be described as an example. In this case, the NC cutting machine 20A corresponds to a first machining center in the invention, and the NC cutting machine 20B corresponds to a second machining center in the invention.

The NC cutting machine 20 is, for example, a machining center. The NC cutting machine 20 includes an NC controller 21, a main body portion 22, and a tool magazine 25.

The NC controller 21 controls, in accordance with an NC program, a machining processing performed on a workpiece W by the main body portion 22 and a tool change processing performed by a tool change portion 26.

The main body portion 22 executes a machining processing on the workpiece W under control of the NC controller 21. The main body portion 22 has a processing head portion 23, a stage 24, and the tool change portion 26. The processing head portion 23 has a spindle on which a tool TL can be mounted and which can rotate the mounted tool TL. The workpiece W to be machine processed is placed on the stage 24. The stage 24 can move the placed workpiece W.

The tool magazine 25 has a plurality of slots 25a, 25b, and 25c. In each of the slots 25a to 25c, the tool TL used in the machining processing is accommodated.

The tool change portion 26 executes, in accordance with control from the NC controller 21, a series of tool change processing in which the tool TL mounted on the processing head portion 23 is removed and accommodated in an empty slot of the tool magazine 25, and the tool TL is taken out from a slot of the tool magazine 25 and mounted on the processing head portion 23.

In the present embodiment, the tool TL includes at least a square end mill used for side surface machining or groove machining of the workpiece W and a ball end mill used for curved surface machining of the workpiece W.

The number of tools TL that can be accommodated in the tool magazine 25 is limited (three in the present embodiment), and all tools required for machining may not be accommodated in the tool magazine 25 at the same time. However, in this case, a plurality of tool sets 27 are prepared in advance, and tool sets accommodated in the tool magazine 25 may be replaced according to the machining processing to be executed so as to correspond to various machining processing.

The on-site computer 30 includes a general computer such as a personal computer including a processor such as a CPU, a storage, a communication interface, an input device, and a display device. The on-site computer 30 is operated by an operator at a site such as a factory where the NC cutting machine 20 is installed. The on-site computer 30 executes a display processing of a conversion input screen and the like, receiving an operation input from an operator to the conversion input screen, downloading an NC program, and the like. When the on-site computer 30 is used for screen display of the conversion computer 10, the on-site computer 30 may be used at a site other than the site where the NC cutting machine 20 is installed. A part or a whole of the conversion processing (described later) by the conversion computer 10 may be shared by the on-site computer 30.

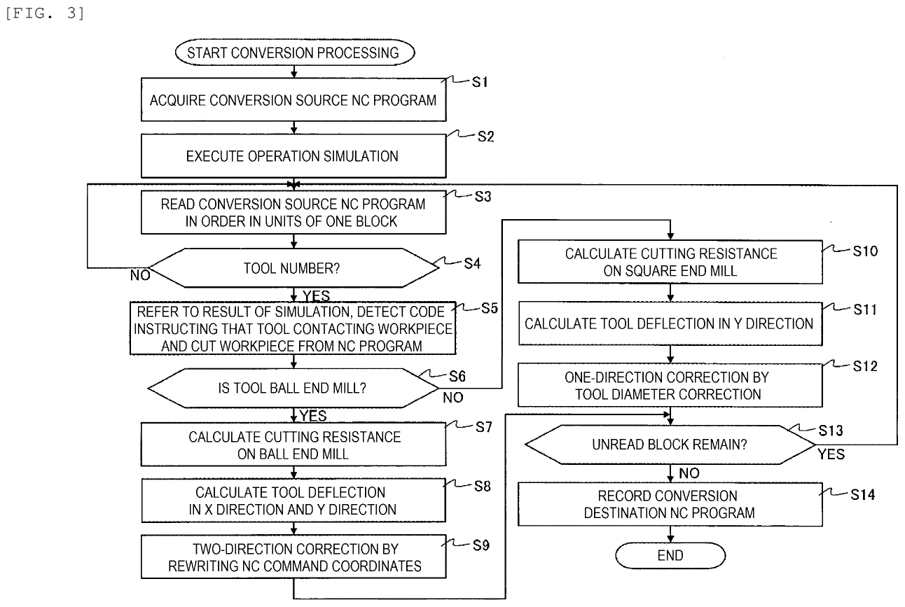

Next, FIG. 2 shows a configuration example of the conversion computer 10.

The conversion computer 10 includes a CPU 11, a communication interface (I/F) 12, a user interface 13, and a storage 14.

The CPU 11 performs the conversion processing by reading and executing a conversion program 141 stored in the storage 14. The CPU 11 performs an information acquisition processing by reading and executing a configuration information acquisition program 142 stored in the storage 14. Here, the information acquisition processing refers to a processing of acquiring information related to the NC cutting machine 20 via the NC controller 21.

The communication interface 12 is connected to the network 40 wirelessly or by wire, and communicates various kinds of information with the NC cutting machine 20 and the on-site computer 30 via the network 40. An input device such as a keyboard, a mouse, and a touch pad is connected to the user interface 13. The user interface 13 receives input from a user using the input device.

The storage 14 includes a hard disk drive (HDD), a solid state drive (SSD), and the like. The storage 14 stores the conversion program 141, the configuration information acquisition program 142, machine configuration information 143, tool set information 144, individual tool information 145, a conversion source NC program 146, a conversion destination NC program 147, and conversion history information 148.

The conversion program 141 and the configuration information acquisition program 142 are stored in advance in the storage 14.

The machine configuration information 143 is information related to each NC cutting machine 20. In the machine configuration information 143, a model number, an installation location, a usage record, a temperature of a predetermined portion, rigidity information of a predetermined portion, a shape of a predetermined portion, the number of slots, an offset value, a manufacturer and a model number of the NC controller 21, and accuracy information are recorded in association with a machine ID of the NC cutting machine 20.

The machine ID is an identifier for individually identifying the NC cutting machine 20, and is acquired from the NC cutting machine 20 via the NC controller 21. Instead of the machine ID, an identifier of the NC controller 21 or a network address of the NC controller 21 may be used.

The model number is information indicating a model of the NC cutting machine 20, and is acquired from the NC cutting machine 20 via the NC controller 21. The installation location is information indicating a location where the NC cutting machine 20 is installed, and is input by an operator or the like using the on-site computer 30.

The usage record is, for example, an accumulated usage time of the NC cutting machine 20, and is acquired from the NC cutting machine 20 via the NC controller 21.

The temperature of a predetermined portion is, for example, a temperature of the spindle of the processing head portion 23, the stage 24, or the like, and is acquired from the NC cutting machine 20 via the NC controller 21. The rigidity information of a predetermined portion is, for example, a Young's modulus and a deflection amount of the spindle of the processing head portion 23, the stage 24, or the like, and is input by an operator or the like using the on-site computer 30. The shape of a predetermined portion is, for example, a length of the spindle of the processing head portion 23 and a length of the stage 24, and is input by an operator or the like using the on-site computer 30.

The number of slots is the number of slots that the tool magazine 25 has, and is acquired from the NC cutting machine 20 via the NC controller 21. The offset value is a value for finely modifying coordinates during tool movement in the NC program, and is acquired from the NC cutting machine 20 via the NC controller 21. The offset value is changed according to change of the NC cutting machine 20 with time or an installation environment, and is used to correct a situation such as the stage 24 being slightly inclined due to deterioration with time, for example.

The accuracy information is information such as rattling of the processing head portion 23, the stage 24, and the like, movement accuracy (for example, a backlash amount of the stage 24), linearity, flatness, translation, a vibration width, and a vibration frequency during a device operation, and is input by an operator or the like using the on-site computer 30.

The tool set information 144 is information for managing a tool set including one or more tools TL. In the tool set information 144, a tool ID (may be a model number) of the tool TL forming the tool set is recorded in association with the tool set ID. The tool set information 144 is input by an operator or the like using the on-site computer 30.

The individual tool information 145 is information related to each tool TL. In the individual tool information 145, a model number, a material, a shape, rigidity information, a use history, and a temperature of the tool TL, and slot information in which the tool TL is to be accommodated are recorded in association with the tool ID of each tool TL. These pieces of information are all input by an operator or the like using the on-site computer 30.

The conversion source NC program 146 is an NC program used for machining processing of the workpiece W in the NC cutting machine 20A as a conversion source. In the conversion source NC program 146, various parameters may be tuned in accordance with a characteristic, a state, and the like of the NC cutting machine 20A as the conversion source. The conversion source NC program 146 is acquired from the NC cutting machine 20A.

The conversion destination NC program 147 is an NC program obtained as a result of a conversion processing that converts the conversion source NC program 146 so as to be suitable for a characteristic, a state, and the like of the NC cutting machine 20B as a conversion destination. In the conversion computer 10, when the conversion processing is not completed at all, the conversion destination NC program 147 is not stored in the storage 14.

The conversion history information 148 is information that manages an execution history of the conversion processing of converting the conversion source NC program 146 into the conversion destination NC program 147. In the conversion history information 148, for example, various kinds of information (input information and the like) used at the time of the conversion processing are recorded in association with identification information of identifying the conversion processing.

Information other than the various kinds of information described above may be stored in the storage 14. For example, the storage 14 may record workpiece information representing shape data before machining of the workpiece W, a material, rigidity, machining target shape data of the workpiece W, and the like.

### Conversion Processing by Conversion Computer 10

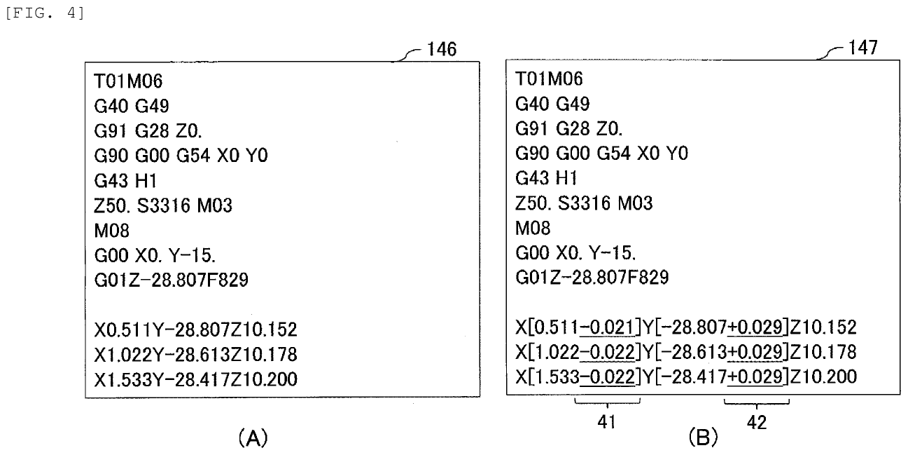

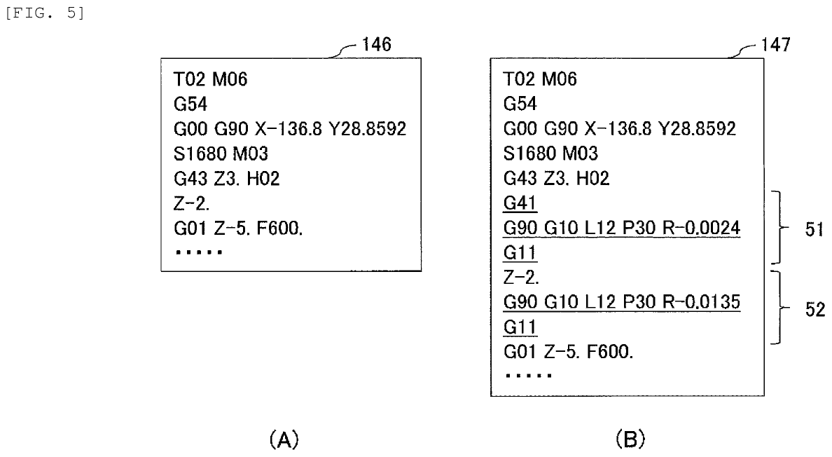

Next, FIG. 3 is a flowchart showing an example of the conversion processing by the conversion computer 10.

The conversion processing is started by the CPU 11 of the conversion computer 10 reading and executing the conversion program 141 stored in the storage 14 in response to a predetermined operation on the conversion computer 10 by a user.

First, (the CPU 11 executing) the conversion program 141 acquires the NC program used in the NC cutting machine 20A as the conversion source from the NC cutting machine 20A, and stores the acquired NC program in the storage 14 as the conversion source NC program 146 (step S1).

Next, the conversion program 141 executes an operation simulation in a case in which the NC cutting machine 20B as the conversion destination performs a machining processing based on the acquired NC program (the conversion source NC program 146) (step S2). In this operation simulation, for example, a positional relationship between a trajectory of the tool TL and the workpiece W can be confirmed.

Next, the conversion program 141 reads the conversion source NC program 146 from the storage 14 in order in units of one block, and stores the conversion source NC program 146 in its own work region (buffer) (step S3). In general, the NC program includes codes such as a G code (preparation function), an F code (feed function), an S code (spindle function), a T code (tool function), and an M code (auxiliary function), and parameters such as a tool coordinate position, and a format of the NC program is determined. Therefore, by registering a format of the NC program for the conversion program 141 in advance, it is easy to read the conversion source NC program 146 in units of one block.

Next, the conversion program 141 determines whether a tool number is included in one block of the conversion source NC program 146 read in step S3 (step S4). In order to determine whether the tool number is included, for example, an M code “TxxM06 (xx is a tool number)” instructing tool change may be detected from a character string of the conversion source NC program 146. As long as it is possible to determine whether the tool number is included, a determination method thereof is optional, and is not limited to the example described above.

Here, when it is determined that the tool number is not included in one block of the conversion source NC program 146 (NO in step S4), the conversion program 141 returns the processing to step S3 and reads a next block of the conversion source NC program 146.

On the contrary, when it is determined that the tool number is included in one block of the conversion source NC program 146 (YES in step S4), the conversion program 141 then specifies the tool number, refers to a result of the operation simulation executed in step S2, goes on reading one block of the conversion source NC program 146, and detects a code instructing that a tool corresponding to the tool number contacts the workpiece W and cuts the workpiece W (step S5). Here, the conversion source NC program 146 is converted into the conversion destination NC program 147 by performing correction described below with respect to the detected code and the subsequent codes.

Next, the conversion program 141 refers to the individual tool information 145 of the storage 14 and determines whether the tool corresponding to the specified tool number is a ball end mill used for the curved surface machining of the workpiece W (whether the tool is a square end mill used for the side surface machining or the groove machining of the workpiece W) (step S6).

Here, when it is determined that the tool is the ball end mill, that is, a machining form is the curved surface machining (YES in step S6), the conversion program 141 calculates cutting resistance applied to the tool (ball end mill), and further decomposes the calculated cutting resistance in a tool traveling direction (X direction) and a direction (Y direction) perpendicular to the tool traveling direction (step S7). Any existing algorithm may be applied to calculate the cutting resistance applied to the ball end mill.

Next, the conversion program 141 calculates, based on the cutting resistance calculated in step S7 and rigidity of the tool obtained from the individual tool information 145, tool deflection in the X direction and the Y direction respectively during machining (step S8). Any existing algorithm may be applied to calculate the tool deflection in the X direction and the Y direction.

Next, the conversion program 141 executes two-direction correction to rewrite a tool route in the conversion source NC program 146 using the tool deflection in the X direction and the Y direction during machining calculated in step S8 (step S9).

FIG. 4 shows a specific example of the two-direction correction. (A) of FIG. 4 shows an example of the conversion source NC program 146, and (B) of FIG. 4 shows an example of the conversion destination NC program 147 obtained by converting the conversion source NC program 146 in (A) of FIG. 4 by the two-direction correction.

An additionally written portion 41 in (B) of FIG. 4 is a correction value in the X direction of the tool route based on the tool deflection in the X direction during machining, and an additionally written portion 42 is a correction value in the Y direction of the tool route based on the tool deflection in the Y direction during machining. In the case of (B) of FIG. 4, although the correction value is visualized by separately showing an original coordinate value and a correction value in [ ], a corrected coordinate value obtained by adding the correction value to the original coordinate value may be shown.

The description returns to FIG. 3. On the contrary, when the conversion program 141 determines that the tool is the square end mill, that is, the machining form is the side surface machining or the groove machining (NO in step S6), the conversion program 141 calculates cutting resistance applied to the tool (square end mill), and further decomposes the calculated cutting resistance in the tool traveling direction (X direction) and the direction (Y direction) perpendicular to the tool traveling direction (step S10). Any existing algorithm may be applied to calculate the cutting resistance applied to the square end mill.

Next, the conversion program 141 calculates, based on the cutting resistance calculated in step S10 and the rigidity of the tool obtained from the individual tool information 145, tool deflection in the Y direction during machining (step S11). Any existing algorithm may be applied to calculate the tool deflection in the Y direction.

Next, the conversion program 141 executes, based on the tool deflection in the Y direction during machining calculated in step S11, one-direction correction to rewrite a tool route in the conversion source NC program 146 by tool diameter correction (step S12).

FIG. 5 shows a specific example of the one-direction correction. (A) of FIG. 5 shows an example of the conversion source NC program 146, and (B) of FIG. 5 shows an example of the conversion destination NC program 147 obtained by converting the conversion source NC program 146 in (A) of FIG. 5 by the one-direction correction.

Additionally, written portions 51, 52 in (B) of FIG. 5 are correction values in the Y direction of the tool route based on the tool deflection in the Y direction during machining. In the case of (B) of FIG. 5, in the additionally written portion 51, although the correction value is set using the G code (G41) instructing the tool diameter correction (also referred to as tool wear correction),the code to be used is not limited. For example, a code changing a tool feed speed may be used.

The description returns to FIG. 3. After step S9 or step S12 is executed, next, the conversion program 141 determines whether a block that is not read in step S3 remains among all blocks of the conversion source NC program 146 acquired in step S1 (step S13). Here, when the conversion program 141 determines that a block that is not read remains (YES in step S13), the processing returns to step S3, and step S3 and the subsequent steps are repeated.

Thereafter, when it is determined that there is no block that is not read (NO in step S13), the conversion program 141 then records, in the storage 14, the conversion destination NC program 147 in which at least one of the two-direction correction in step S9 and the one-direction correction in step S12 is reflected. Thus, the conversion processing is ended.

The conversion destination NC program 147 recorded in the storage 14 is downloaded by the on-site computer 30B at a predetermined timing, transmitted to the NC controller 21 of the NC cutting machine 20B, and used to control a machining processing of the workpiece W by the NC cutting machine 20B.

According to the conversion processing described above, the machining form of the workpiece W is determined based on a type of the tool used for machining the workpiece W, and the conversion source NC program 146 optimized for the NC cutting machine 20A can be converted into the conversion destination NC program 147 suitable for the NC cutting machine 20A by a correction method according to the machining form. Accordingly, for example, even in the machining processing of the workpiece W having a complicated curved surface such as a mold, it is possible to improve machining accuracy in the NC cutting machine 20B.

In the conversion processing described above, although the correction method is decided according to the machining form of the workpiece W, a user may decide the correction method.

### Modification

In the two-direction correction in step S9 of the conversion processing described above, when an interval between command coordinate points in the conversion source NC program 146 is wide, the cutting resistance may greatly change between the command coordinate points. Therefore, in a case in which the interval between the command coordinate points in the conversion source NC program 146 is wider than a predetermined threshold value and a difference between correction amounts of the command coordinate points is larger than a predetermined threshold value, not only the command coordinate points are rewritten, but also interpolation points may be provided between rewritten command coordinate points.

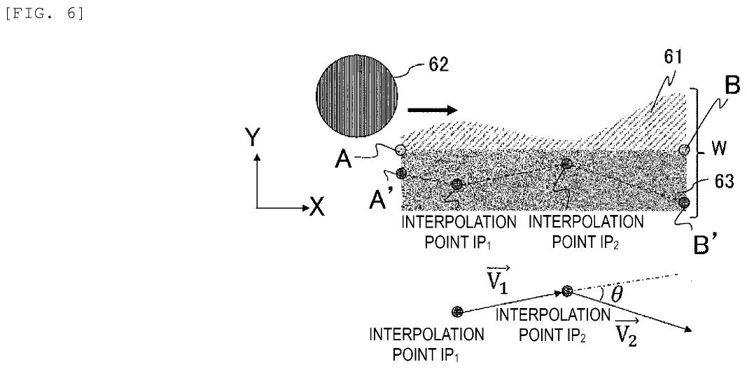

FIG. 6 is a diagram showing a method of providing interpolation points in the two-direction correction. For example, as shown in the figure, an NC program is considered for controlling machining in which, using a ball end mill 62, a hatched region 61 of the workpiece W is cut to leave a region 63 so that a straight line is formed between points A and B.

When an interval between the command coordinate points A and B in the conversion source NC program 146 is wider than a predetermined threshold value and a difference between correction amounts of the command coordinate points A and B, which is |(A′-A) to (B′-B)|, is larger than a predetermined threshold value, as shown in the figure, not only the command coordinate points A and B in the conversion source NC program 146 are simply rewritten to the command coordinate points A′ and B′, but also interpolation points IP₁ and IP₂ are provided according to cutting resistance between the points A′ and B′ to rewrite the command coordinate points.

By providing the interpolation points IP₁ and IP₂, when an angle θ formed by a tool route movement vector V₁ at the interpolation point IP₁ and a tool route movement vector V₂ at the interpolation point IP₂ exceeds a predetermined threshold value, a step may be generated on a machining surface that should be linear in the vicinity of the interpolation point IP₂. In such a case, an alert may be output to a user.

The invention is not limited to the embodiment described above, and various modifications can be made. For example, the embodiment described above has been described in detail for easy understanding of the invention, and is not necessarily limited to those including all the configurations described above. A part of a configuration of an embodiment may be replaced with or added to a configuration of another embodiment.

A part or all of the above configurations, functions, processing units, processing units, and the like may be implemented by hardware, for example, by designing an integrated circuit. The above-mentioned configurations, functions, and the like may be implemented by software by a processor interpreting and executing a program that implements respective functions. Information such as a program, a table, and a file for implementing each function can be placed in a memory, a recording device such as a hard disk or SSD, or a recording medium such as an IC card, an SD card, or a DVD. Control lines or information lines indicate what is considered necessary for description, and not all of the control lines or information lines are necessarily shown in a product. It may be considered that almost all configurations are actually connected to each other.

### REFERENCE SIGNS LIST

1 machining system
10 conversion computer
12 communication interface
13 user interface
14 storage
141 conversion program
142 configuration information acquisition program
143 machine configuration information
144 tool set information
145 individual tool information
146 conversion source NC program
147 conversion destination NC program
148 conversion history information
20 NC cutting machine
21 NC controller
22 main body portion
23 processing head portion
24 stage
25 tool magazine
25a to 25c slot
26 tool change portion
27 tool set
30 on-site computer
40 network
61 hatched region
62 ball end mill
63 region

1. An NC program conversion processing method for converting a conversion source NC program that controls a first machining center into a conversion destination NC program that controls a second machining center, the NC program conversion processing method comprising:
a determination step of determining a machining form of a workpiece by the conversion source NC program;
a decision step of deciding a correction method to be one-direction correction or two-direction correction according to the determined machining form of the workpiece; and
a conversion step of converting the conversion source NC program into the conversion destination NC program using the decided correction method.

2. The NC program conversion processing method according to claim 1, wherein
the determination step determines the machining form based on a type of a tool used for machining the workpiece.

3. The NC program conversion processing method according to claim 2, wherein
the determination step
determines, in a case in which the tool used for machining the workpiece is a ball end mill, the machining form to be curved surface machining, and
determines, in a case in which the tool is a square end mill, the machining form to be side surface machining or groove machining.

4. The NC program conversion processing method according to claim 1, wherein
the decision step
decides, in a case in which the machining form is determined to be curved surface machining, the correction method to be the two-direction correction, and
decides, in a case in which the machining form is determined to be side surface machining or groove machining, the correction method to be the one-direction correction.

5. The NC program conversion processing method according to claim 1, wherein
the conversion step
converts, in a case in which the correction method is the one-direction correction, the conversion source NC program into the conversion destination NC program by tool diameter correction, and
converts, in a case in which the correction method is the two-direction correction, the conversion source NC program into the conversion destination NC program by adding a correction amount to a command coordinate point in the conversion source NC program.

6. The NC program conversion processing method according to claim 5, wherein
the conversion step
converts, in a case in which the correction method is the two-direction correction, the conversion source NC program into the conversion destination NC program by adding the correction amount to be added to the command coordinate point in the conversion source NC program.

7. The NC program conversion processing method according to claim 5, wherein
the conversion step
provides, in a case in which the correction method is the two-direction correction, and an interval between command coordinate points in the conversion source NC program is wider than a predetermined threshold value and a difference between correction amounts of the command coordinate points is larger than a predetermined threshold value, an interpolation point between command coordinate points after correction.

8. A conversion computer that includes a processor and converts a conversion source NC program that controls a first machining center into a conversion destination NC program that controls a second machining center, wherein
the processor
determines a machining form of a workpiece by the conversion source NC program;
decides a correction method to be one-direction correction or two-direction correction according to the determined machining form of the workpiece; and
converts the conversion source NC program into the conversion destination NC program using the decided correction method.

9. A conversion program, wherein
a processor is caused to execute the NC program conversion processing method according to claim 1.
